(19) United States
(12) Patent Application Publication
(10) Pub. No.: US 2009/0041918 A1
(43) Pub. Date: Feb. 12, 2009

(54) NON-COHESIVE WAXY FLOURS AND METHOD OF PREPARATION

(76) Inventor: Yong-Cheng Shi, Manhattan, KS (US)

Correspondence Address: GREENBERG TRAURIG, LLP, 200 PARK AVE., P.O. BOX 677, FLORHAM PARK, NJ, 07932, US

(21) Appl. No.: 12/172,204

(22) Filed: Jul. 11, 2008

Related U.S. Application Data
(60) Provisional application No. 60/958,985, filed on Jul. 11, 2007.

(51) Int. Cl. A21D 6/00; A23L 1/10

(52) U.S. Cl. 426/555; 426/465

(57) ABSTRACT

Waxy flour products exhibiting noncohesive textures and methods of making same are disclosed, with an example of the method comprising the steps of: Obtaining a waxy flour; and heat treating the waxy flour, wherein the pH of the waxy flour is not adjusted during this method.

### CROSS-REFERENCE TO RELATED APPLICATIONS

This nonprovisional patent application claims priority to U.S. Provisional Patent Application Ser. No. 60/958,985, filed on Jul. 11, 2007.

### BACKGROUND OF THE INVENTION

Starch is most abundant in the endosperm of cereal grains, root and tuber plants. Starch is a carbohydrate composed of two types of glucose polymers, amylose and amylopectin. Amylose is essentially a linear polymer, whereas amylopectin is a highly branched large molecule. The term “waxy” is used to describe starch that contains amylopectin but little or no amylose.

Typically, when cooked in water, waxy flour gives a cohesive texture, which is often not desirable in food systems as a thickener. In addition, waxy flour shows a significant breakdown in viscosity, particularly at low pH, which is not desirable either in food systems. This invention discloses methods to prepare waxy flours that give non-cohesive texture and viscosity stability in a variety of conditions. These thermally treated waxy flours will find wide applications in foods.

### BRIEF SUMMARY OF THE INVENTION

In one embodiment, the instant invention relates to a method comprising the steps of obtaining a waxy flour; and heat treating the waxy flour, wherein the pH of the waxy flour is not adjusted during this method.

In one embodiment, the instant invention relates to a method wherein the water content of the waxy flour is not adjusted during this method. In another embodiment, the pH of the waxy flour is between 4.5 and 7.5. In one embodiment, the water content of the waxy flour is between about 0 and about 18%. In another embodiment, the water content of the waxy flour is adjusted to between about 0 and about 18% during this method. In another embodiment, a waxy flour is obtained using any of the above methods.

In another embodiment, the instant invention relates to a method comprising the steps of: obtaining a waxy flour; and heat treating the waxy flour, wherein the waxy flour is dehydrated prior to heat treating. In another embodiment, the water content of the waxy flour is between about 0 and about 18% during this method. In another embodiment, the pH of the waxy flour is between about 4.5 and about 7.5% during this method. In another embodiment, the pH of the waxy flour is adjusted to between about 4.5 and about 7.5 during this method. In another embodiment, the heat treated waxy flour exhibits higher viscosity than comparable non-heat treated waxy flours. In another embodiment, the heat treated waxy flour exhibits less viscosity breakdown than comparable non-heat treated waxy flours. In another embodiment, the decrease in viscosity breakdown of heat treated waxy flour is observable in heat treated waxy flour with acidic pH. In another embodiment, a heat treated waxy flour obtained using any of the above methods.

In another embodiment, the heat treated waxy flour exhibits higher viscosity than comparable non-heat treated waxy flours. In another embodiment, the heat treated waxy flour exhibits less viscosity breakdown than comparable non-heat treated waxy flours. In another embodiment, the decrease in viscosity breakdown of heat treated waxy flour is observable in heat treated waxy flour with acidic pH. In another embodiment, the heat treated waxy flour exhibits less syneresis than comparable non-heat treated waxy flours. In another embodiment, the heal treated waxy flour is selected from the group consisting of wheat, soft waxy wheat, hard waxy wheat, rice, corn, barley, sorghum, potato, cassava flour. In another embodiment, the heat treated waxy flour exhibits decreased cohesion when subsequently heated in the presence of water as compared to non-heat treated waxy flour.

In another embodiment, the heat treated waxy flour is incorporated into a food product. In another embodiment, the food product into which the heat treated waxy flour is incorporated into a bakery product. In another embodiment, the bakery product has increased volume and good texture. In another embodiment, the heat treated waxy flour is incorporated into a dough that is less sticky and less ductile than dough incorporating non-heat-treated waxy flour. In another embodiment, the invention relates to a waxy flour having an L value greater than about 88.0 and non-cohesive texture when cooked in water.
For the purposes of describing and claiming the present invention, the following terms are defined:
“Adjusted” means: changing the physical or chemical characteristic of a material by means other than heat treatment.
“Ductile” means: Capable of being easily deformed plastically without fracture.
“Flour” means: ground or milled grain or cereal.
“Heat treating” means to cause an increase in temperature of an object or space; to cause something to become hot; and includes utilization of methods of heat treatment that are both “closed” (eg within a sealed space) and “open” (eg within a vessel that is open to the ambient environment). Meat treatment further refers to the entire period of time when heat is applied, eg from the initial ambient temperature to any elevated temperature and return to the ambient temperature.
“Moisture Content” means percentage, by weight, of water present in a sample.
“Non-cohesive Texture” means: non-cohesive, short texture, which may be visually characterized by inspection of the texture of the resultant flour or flour and water mixture and can also be measured using rheological measurement techniques.
“Syneresis” means: the tendency of a material to weep or exude moisture; for example, when the material is stored at a cold temperature.
“Viscosity” means: The resistance of a liquid to flow.
“Viscosity Breakdown” means the difference between peak viscosity and hot viscosity as measured by RVA.
“Water Content” means the percentage by weight of water contained in a substance.
“Waxy Flour” means flour having a starch content that has a greater percentage by weight of amylopectin and amylopectin derivatives than amylose and amylose derivatives.

### BRIEF DESCRIPTION OF THE SEVERAL VIEWS OF THE DRAWINGS

FIG. 1 is a graphical, depiction of the temperature and apparent viscosity of a typical waxy flour product (1.0% w/v flour in water) analyzed using the RVA method. “Peak Viscosity” represents the highest apparent viscosity achieved upon heating the sample; “Hot Paste Viscosity” refers to the apparent viscosity of a sample at the end of the period of holding the sample at an elevated temperature; “Break Down Viscosity” refers to the difference between peak viscosity and hot paste viscosity; “Cold Paste Viscosity” refers to the viscosity at the conclusion of the lower-temperature hold period following the cooling of the sample; and “Set Back” refers to the difference between hot paste and cold paste viscosity.

FIG. 2 is a graphical depiction of apparent viscosity as a function of time for several types of waxy flour.

FIG. 3 is a graphical depiction of apparent viscosity as a function of time for Soft Normal Wheat flour subjected to a variety of heat treatments.

FIG. 4 is a graphical depiction of apparent viscosity as a function of time for Hard Normal Wheat flour subjected to a variety of heat treatments.

FIG. 5 is a graphical depiction of apparent viscosity as a function of time for Soft Waxy Wheat flour subjected to a variety of heat treatments.

FIG. 6 is a graphical depiction of apparent viscosity as a function of time for Hard Normal Waxy Wheat flour subjected to a variety of heat treatments.

FIG. 7 is a graphical depiction of apparent viscosity as a function of time for Soft Waxy Wheat flour subjected to closed and open heat treatments.

FIG. 8 is a graphical depiction of apparent viscosity as a function of time for Hard Waxy Wheat flour that is assayed via RVA at neutral or slightly acidic pH and that is subjected to closed and/or open heat treatment.

FIG. 9 is a graphical depiction of viscosity as a function of time for Hard Waxy Wheat flours assayed via RVA at neutral pH, subjected to varying periods of open heat treatment at 105 degrees Celsius and 165 degrees Celsius in, plotted against a control, non-heat-treated sample.

FIG. 10 is a graphical depiction of viscosity as a function of time for Hard Waxy Wheat flours assayed via RVA at neutral pH, subjected to varying periods of closed heat treatment at 105 degrees Celsius and 165 degrees Celsius in, plotted against a control, non-heat-treated sample.

FIG. 11 is a graphical depiction of viscosity as a function of time for waxy Hard Waxy Wheat flour starch subjected to heat treatment at 165 degrees Celsius for 30 minutes, plotted against a control, non-heat-treated sample.

FIG. 12 is a graphical depiction of one step direct heat treatment viscosity as a function of time for waxy wheat flour assayed via RVA at neutral pH (eg 6.0), subjected to heat treatment at 165 degrees Celsius for 30 minutes, plotted against a control, non-heat-treated sample,

FIG. 13 is a graphical depiction of heat treatment viscosity as a function of time for waxy wheat flour, assayed via RVA at acidic pH (eg 3.0) subjected to heat treatment at 165 degrees Celsius for 30 minutes, plotted against a control, non-heat-treated sample.

FIG. 14 is a graphical depiction of closed heat treatment viscosity as a function of time for waxy wheat flour, assayed via RVA at neutral pH (eg 6.0) and increased moisture content (18%) subjected to heat treatments of 105 and/or 165 degrees Celsius for 30 minutes, plotted against a control, non-heat-treated sample.

FIG. 15 is a graphical depiction of open and closed heat treatment viscosity as a function of time for rice flour, assayed via RVA at neutral pH (eg 6.0), subjected to heat treatments of 160 degrees Celsius for various amounts of time.

FIG. 16 is a graphical depiction of open and closed heat treatment viscosity as a function of time for rice flour, assayed via RVA at acidic pH (eg 3.0), subjected to open and closed heat treatments of 160 degrees Celsius for various amounts of time.

FIGS. 17(a)-(k) are graphical mixogram curve depictions of rheological properties of flours heat treated utilizing a variety of starting flour material, heat treatment time and heat treatment temperature parameters.

FIG. 18 is a graphical description of viscosity as a function of time for waxy wheat flours heat treated for a variety of times and assayed via RVA at both neutral and slightly acidic pH.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

In one embodiment, the present invention relates to non-cohesive waxy Hours and the method for their production. In one example, when untreated waxy wheat flour is heated in water at 10% solids, the waxy flour results in a cohesive or stringy texture. In another example, when untreated waxy wheat flour is analyzed by a Rapid Visco Analyzer (RVA), the untreated waxy wheat flour shows a significant reduction of viscosity (breakdown) after it reaches a peak viscosity.

In another embodiment, the flour can be heated from about 1 minute to 240 minutes.

In another embodiment, the flour can be heated at temperatures ranging from about 100 degrees C. to 180 degrees C. In another embodiment, the flours are heated at temperatures ranging from 120 to 170 degrees C. In another embodiment, the flours are heated at a temperature ranging from 130 to 165 degrees C.

In another embodiment, the pH of flour during the heat treatment can range from about 4.5 to 8.5. In another embodiment, the pH can range from 5.5 to 7.5. In one embodiment, the pH of the flour is not adjusted during the method of the present invention. In another embodiment, the pH of flour can be adjusted prior or subsequent to heat treatment.

In another embodiment, the moisture content of flour during the heat treatment can range from 0-18%. In another embodiment, the flour is substantially anhydrous. In another embodiment, the moisture content of the flour is unchanged save by the heat treatment itself. In another embodiment, the moisture content of the flour can be adjusted prior or subsequent to heat treatment.

In another embodiment, the heat-treated waxy flours give a non-cohesive, short texture when cooked in water. In another embodiment, the heat-treated waxy wheat flours give higher viscosity than the native waxy wheat flours and less viscosity breakdown as determined by RVA both at neutral and slightly acidic pH conditions.

In another embodiment, one or more of the following four parameters may be adjusted in order to achieve the desired result: substantially acidic to substantially neutral pH, temperature, time, and substantially anhydrous to substantially low moisture content. For example, if a higher temperature is used, the time can be decreased. The results show that the heat-treated waxy wheat fours function like inhibited starches and give stable viscosity at acidic conditions, which is desirable in food systems having low pH such as cherry pie filling. These heat-treated waxy wheat flours give less viscosity breakdown compared with native wheat flours, and could replace chemically cross-linked starches, which are used in wide food applications as thickeners. Moreover, when the cooked waxy wheat flours were stored in a refrigerator for two weeks, no syneresis was observed. This indicates that the heat-treated waxy wheat flour also gives good cold temperature storage stability.

In another embodiment, no chemicals are used in the present invention. In another embodiment, waxy flours heat treated at neutral pH develops a lighter color when compared with the flours that are heat treated at high pH. In another embodiment, heat treated waxy wheat flours functions similarly to a chemically modified starch but can be labeled as wheat flour, which may offer advantages in “all natural” foods or in applications where a wheat flour label is desired and a chemically modified starch is not desirable or not allowed.

In another embodiment, any of a variety of plant sources for waxy flours may be utilized, including, but not limited to, heat treated waxy wheat flours, waxy rice flours, waxy corn flours, waxy barley flours, waxy sorghum flours, waxy potato flours, waxy cassava flours, and other waxy Hours. In another embodiment, the pH of the flour is maintained throughout the process. In another embodiment, heat treated flours from any of these sources can be used in various food and non-food systems (e.g. personal care, adhesive) as thickeners, stabilizers or as ingredients for various baking applications. In another embodiment, the heat processed waxy flours will find applications in food, soups, sauces, beverages, personal care products, adhesives etc. In another embodiment, the heat-treated flour can be pre-gelatinized, recovered, and become cold water-soluble when it is re-dispersed in water. In another embodiment, the cold-water soluble specialty flour can be used in sauces, soups, and ready-to-eat meals. In another embodiment, the heat-treated flours can be used in various bakery goods.

In another embodiment, the heat-treated waxy flours can be pre-gelatinized (or cooked) and recovered. The common pre-gelatinization methods include jet-cooking and spray drying, drum drying, and extrusion. In another embodiment, the heat-treated flours have properties including non-cohesive texture when cooked in water, stable viscosity in substantially acidic conditions, shear resistance, less viscosity breakdown (as observed by RVA), and cold storage stability.

In another embodiment, the protein content of flours can be reduced by milling process or by enzymatic (protease) treatment. As a result, the starch content can be increased. In another embodiment, the low protein waxy wheat flour could have a higher viscosity than the flour with high protein content.

In another embodiment, no chemical is used in the process. In another embodiment, because the heat treatment is done at neutral pH, the color of the heated treated products would be lighter than the color of the flours treated at alkaline pH. In another embodiment, because the heat-treated flours can be made under anhydrous conditions or limited moisture, a wide range of equipment can be used to make the products. In another embodiment, the heat-treated products can be labeled as “flour”, which may be desirable in many applications where a chemically modified starch is not desired or allowed.

Suitable heat treatment times include, but are not limited to, 0-0.5 hours, 0-1 hours. 1-2 hours, 2-3 hours, 3-4 hours, 4-5 hours, or 5-6 hours. For lower temperatures, longer heating times may be required.

Dehydration may involve dehydrating the flour until it is anhydrous or substantially anhydrous. The dehydration may be a thermal dehydration or a non-thermal dehydration. The thermal dehydration is carried out by heating the starch in a convention oven or a microwave oven, or any other heating device for a time and at a temperature sufficient to reduce the moisture content to less than 1%, preferably 0%. Examples of non-thermal dehydrating methods include extracting the water from the granular starch or pregelatinized starch using a hydrophilic solvent such as an alcohol (e.g., ethanol) or freeze drying the starch.

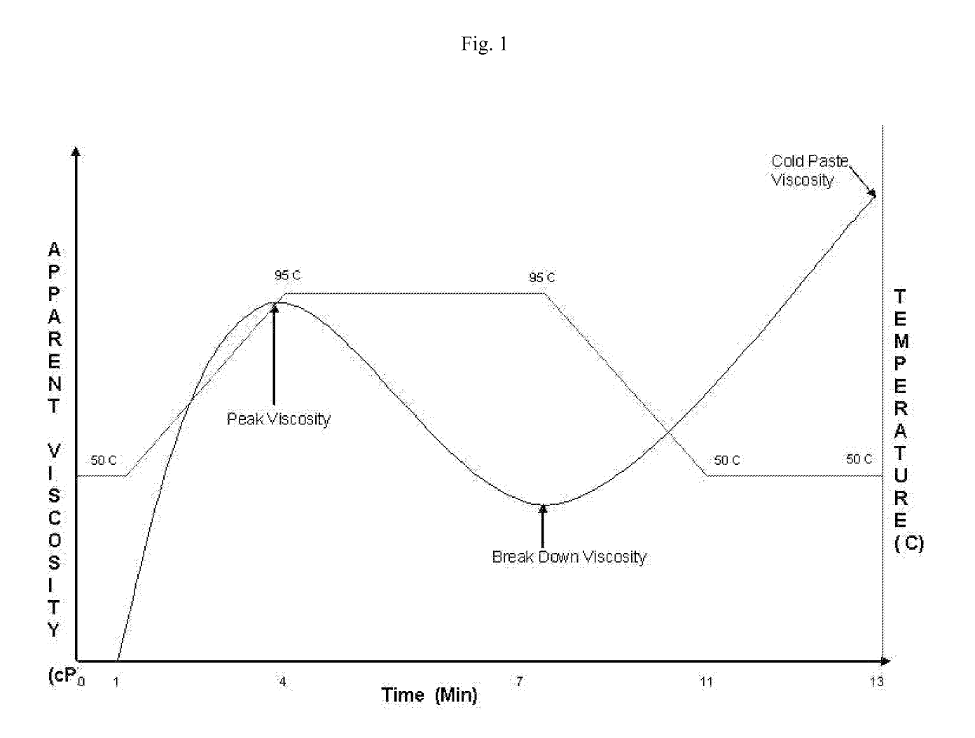

Rapid Visco Analyzer (RVA) method was used to determine pasting properties of flour and heat treated flour for some of the following examples. The RVA method entails the following: A 25-gm test mixture of flour and water (10% solids level) was prepared in an RVA (Rapid Visco Analyzer, Model RVA-4) canister. This test is used to determine the pasting properties of flours. The onset of gelatinization is indicated by an increase in die viscosity of the starch slurry as the starch granules begin to swell. If required, the slurry is pH adjusted for test purposes. An RVA paddle was inserted into the canister and the mixture was gently agitated to disperse and flour lumps. The RVA canister was then subjected to a 13 minute RVA test to determine flour pasting properties. The RVA pasting curve profile included holding the sample at 50° C. for 1 min followed by heating the sample from 50 to 95° C. in 3 min; holding the sample at 95° C. for 3 min; cooling the sample back to 50° C. in 4 min; holding the sample at 50° C. for 2 min. Pasting properties included peak viscosity, hot paste viscosity and cold paste viscosity (FIG. 1). ‘Break Down’ is the difference between peak viscosity and hot paste viscosity, while ‘Set Back’ is the difference between cold paste viscosity and hot paste viscosity.

For the following examples, wheat flours used included Hard Normal Wheat (HNW)—hard winter red wheat flour; Soft Normal Wheat (SNW) flour; Soft Waxy Wheat (SWW) flour; and Hard Waxy Wheat (HWW) flour.

### Experiment 1: Comparing Pasting Properties of Different Flours

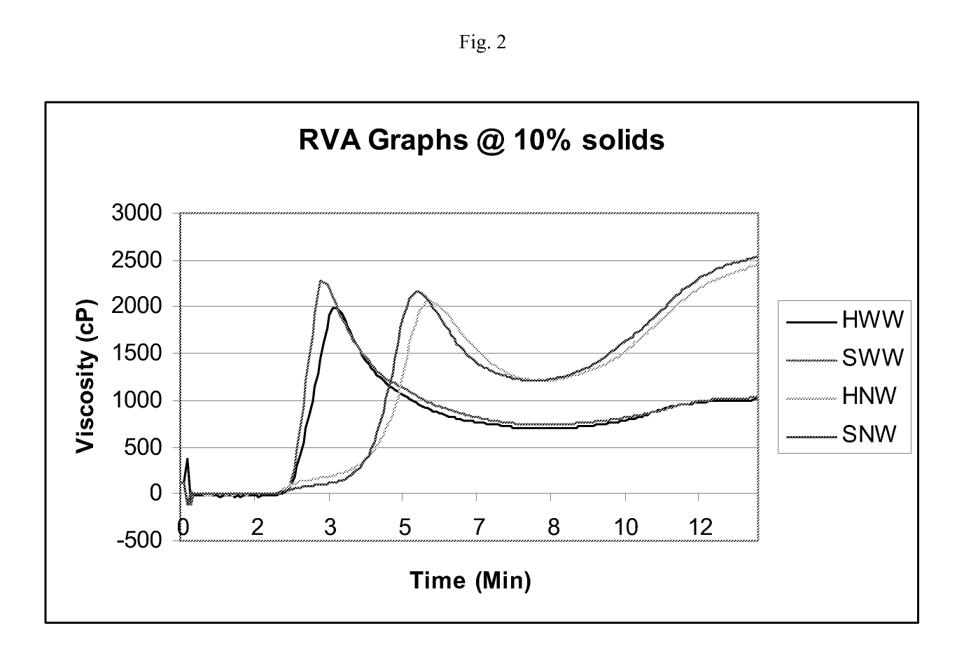

Pasting properties of HNW, HWW, SNW and SWW were determined by RVA. An overlaid graph of pasting curves of different flours can be seen in FIG. 2 and pasting properties are given in Table 1. The peak viscosity of SWW flour was higher than that of SNW and HNW flours. Additionally, peak viscosity for SWW flour was observed earlier, at 3.3 min, whereas peak viscosity for SNW and HNW was found at 5.6 min. The hot paste viscosity of SWW flour was lower than that of SNW and HNW flours. The cold paste viscosity for SWW flour was significantly lower as compared to SNW and HNW flours. Large breakdown in viscosity was observed for waxy wheal flours and the cooks of waxy wheat flours exhibited cohesive textures.

TABLE 1
Pasting properties of different curves at 10% solids.

| Sample/ | Peak | Hot Paste | | Cold Paste | |
|---|---|---|---|---|---|
| Property | Viscosity | Viscosity | Break Down | Viscosity | Set Back |
| SNW | 2107 | 1222 | 885 | 2473 | 1252 |
| HNW | 2167 | 1249 | 918 | 2538 | 1289 |
| SWW | 2338 | 777 | 1561 | 1086 | 309 |
| HWW | 1995 | 697 | 1298 | 1007 | 310 |

### Experiment 2: Effect of Heating on Different Flours

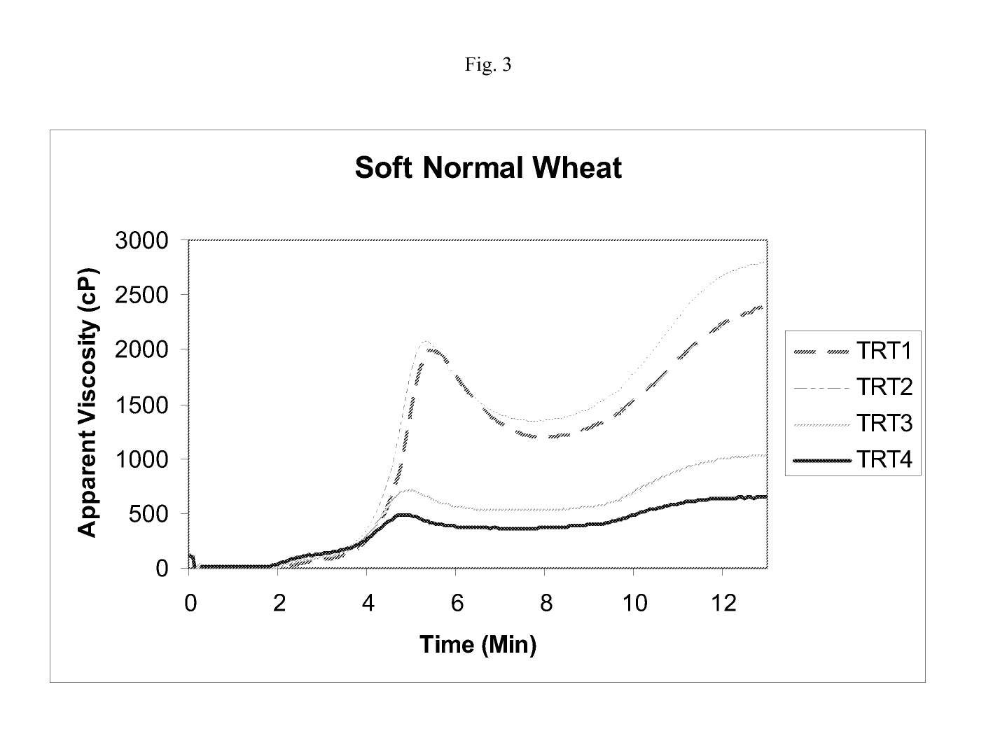

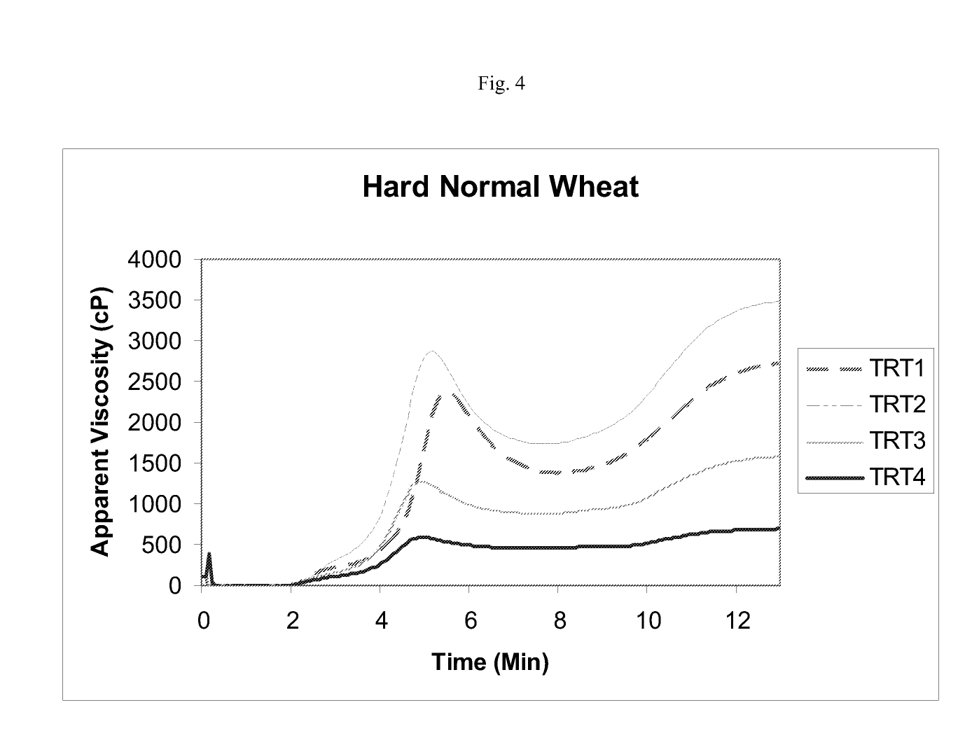

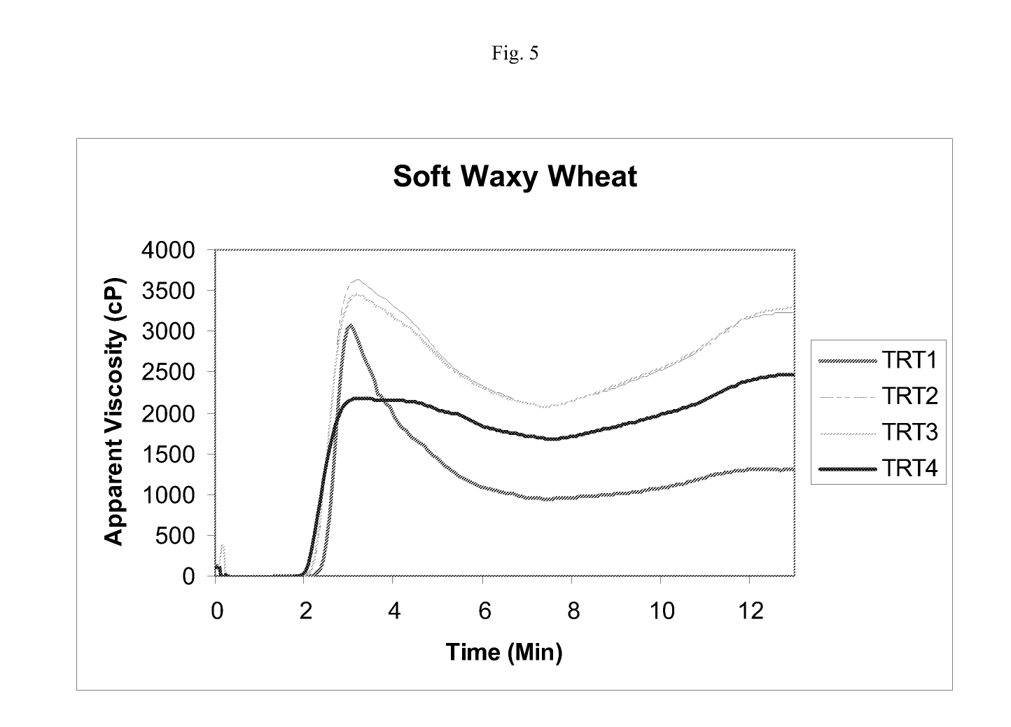

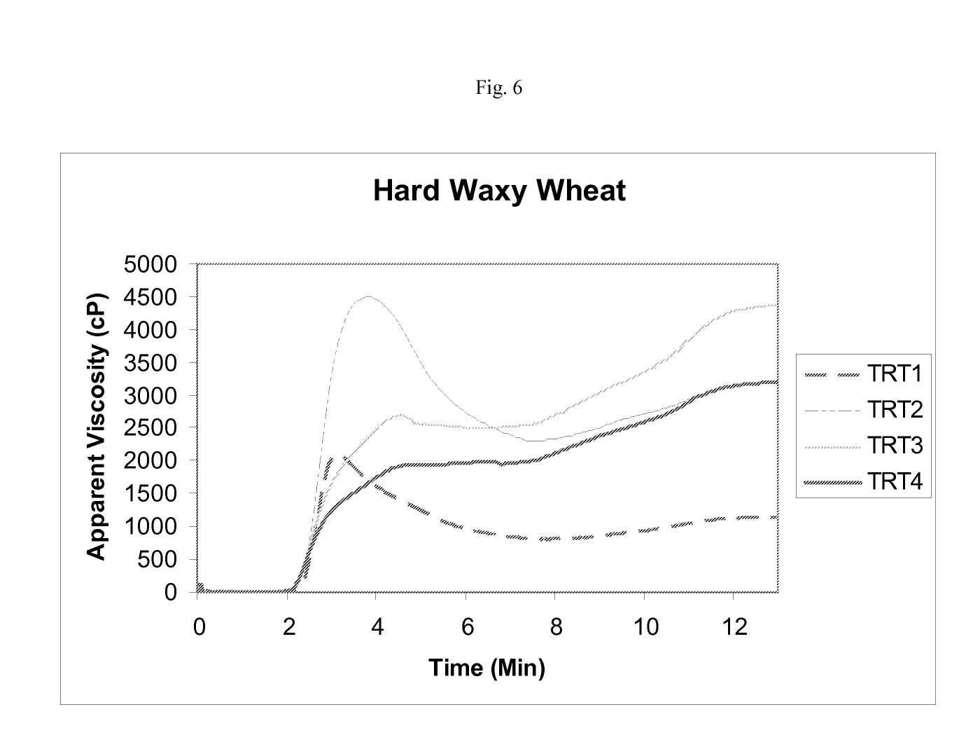

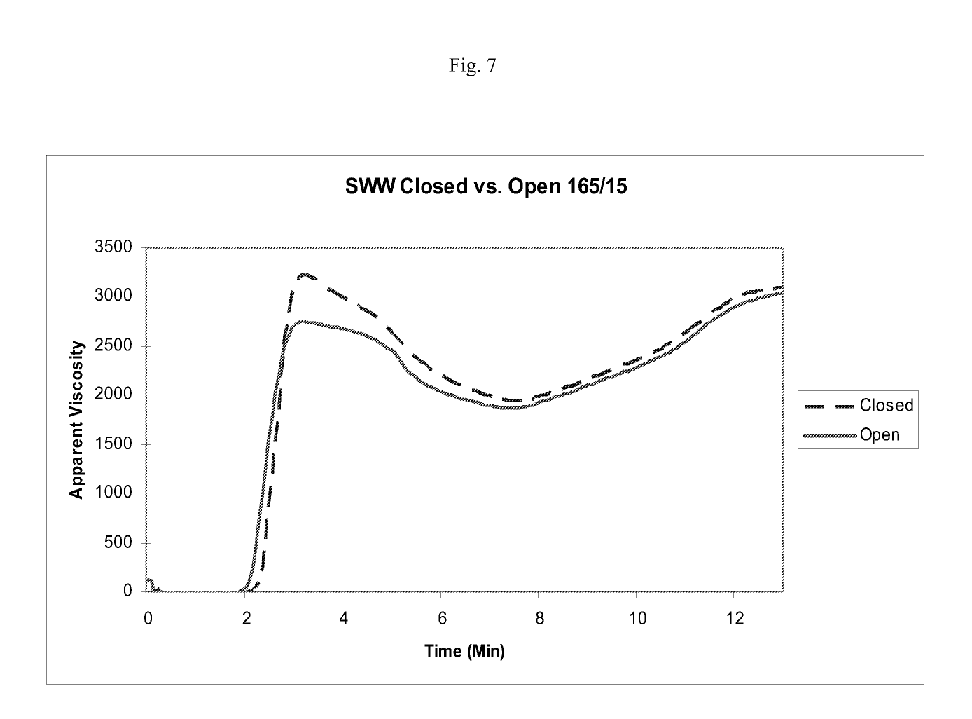

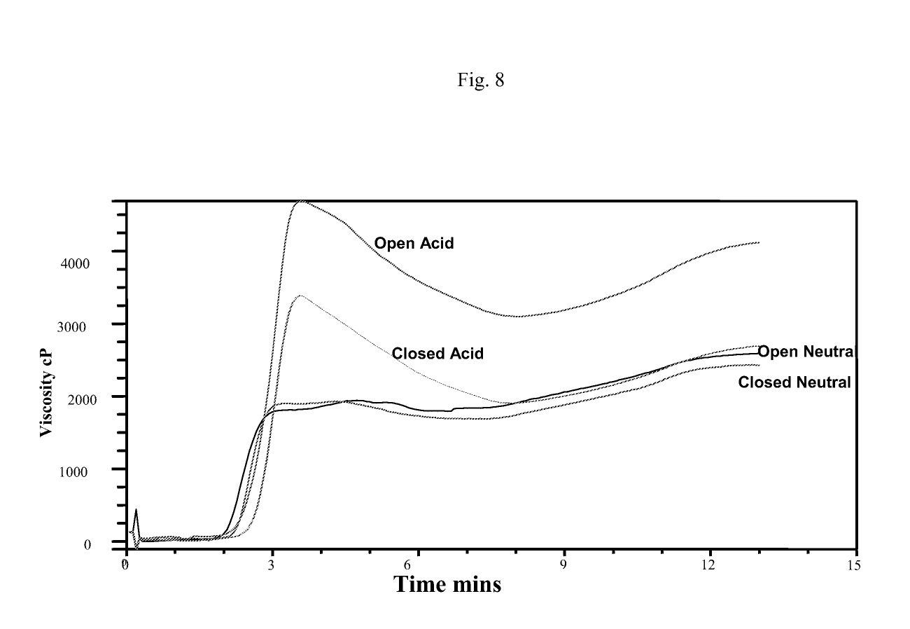

The wheat flour samples were subjected to various heating profiles. Flours (15 g each) were evenly spread onto a plate and heated in an oven. The heating profile included heating the sample at 105° C. for 30 min followed by increasing the temperature of the oven to 165±3° C. The plates were drawn out at regular intervals as described in each individual experiment.
Each of the four flours i.e. SNW, HNW, SWW and HWW, was subjected to four different heat treatments.
   Treatment 1 (TRT1): 105° C. for 30 min
   Treatment 2 (TRT2): 105° C. for 30 min and additional time till the oven reached the temperature of 165±3° C.
   Treatment 3 (TRT3): 105° C. for 30 min and an additional 10 min at 165±3° C.
   Treatment 4 (TRT4): 105° C. for 30 min and an additional 30 min at 165±3° C.
The flours were then cooled to room temperature over a period of 18 hours. The samples were then analyzed for their pasting properties using an RVA. Pasting curves are given in FIGS. 3-6. The pasting properties of four different flours for each heat treatment are given in Table 2.

TABLE 2
Pasting properties of different flours for each heat treatment.

| | | | | | |
|---|---|---|---|---|---|
| | Peak | Hot Paste | | Cold Paste | |
| Treatment | Viscosity | Viscosity | Break Down | Viscosity | Set Back |

SNW

| | | | | | |
|---|---|---|---|---|---|
| TRT1 | 2016 | 1217 | 799 | 2441 | 1224 |
| TRT2 | 2114 | 1363 | 751 | 2850 | 1487 |
| TRT3 | 644 | 475 | 169 | 922 | 447 |
| TRT4 | 464 | 348 | 116 | 608 | 260 |

HNW

| | | | | | |
|---|---|---|---|---|---|
| TRT1 | 2371 | 1376 | 995 | 2725 | 1350 |
| TRT2 | 2859 | 1723 | 1136 | 3474 | 1752 |
| TRT3 | 1212 | 838 | 374 | 1504 | 666 |
| TRT4 | 594 | 456 | 138 | 711 | 256 |

SWW

| | | | | | |
|---|---|---|---|---|---|
| TRT1 | 2975 | 913 | 2062 | 1262 | 349 |
| TRT2 | 3537 | 2066 | 1471 | 3185 | 1119 |
| TRT3 | 3395 | 2045 | 1350 | 3239 | 1194 |
| TRT4 | 2214 | 1685 | 529 | 2507 | 823 |

HWW

| | | | | | |
|---|---|---|---|---|---|
| TRT1 | 2146 | 824 | 1322 | 1323 | 327 |
| TRT2 | 4645 | 2347 | 2298 | 2298 | 870 |
| TRT3 | 3086 | 2553 | 533 | 208 | 1915 |
| TRT4 | 2401 | 1963 | 160 | 2299 | 1289 |

For normal wheat varieties (both SNW and HNW) the peak viscosity, hot paste viscosity and cold paste viscosity values were highest for TRT2 and followed the order TRT2>TRT1>TRT3>TRT4. Heat treated HWW mid SWW flours had higher hot viscosity and cold viscosity than that of un-treated HWW and SWW flours. Un-treated HWW and SWW flours exhibited cohesive textures after cooking whereas HWW and SWW flours exhibited non-cohesive textures after being treated at 165° C. Viscosity breakdown was reduced after heat treatment of waxy wheat flours.

### Experiment 3: Heat-Treatment of Hard Waxy Wheat Flour—Open Conditions

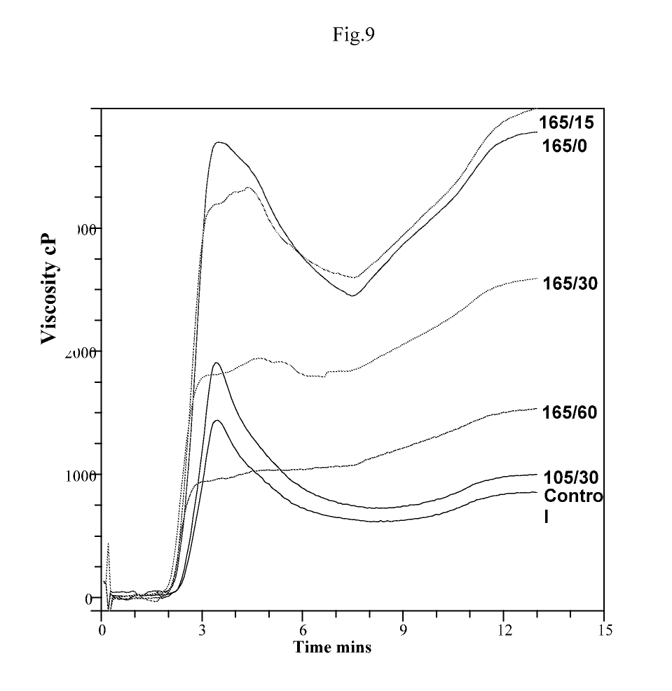

Hard winter waxy wheat flours (15 g each) were evenly spread onto a plate and heated at 105° C. for 30 minutes and then the oven temperature was increased to 165° C. and the flours were held for 0, 15, 30, or 60 minutes. The pasting curves (10% solids, neutral pH) of heat treated samples and un-treated hard waxy wheat flour were shown below. Heat treated hard waxy wheat flours had higher viscosity than the un-treated hard waxy wheat flour (control). (FIG. 9) Viscosity breakdown was reduced after heat treatment (165° C., 30 min) and the cook was non-cohesive. After RVA measurements, the cooked waxy wheat flours were stored in a refrigerator. After 3 weeks of storage, no syneresis was observed, indicating that the heat treated waxy wheal flours had good cold storage stability.

### Experiment 4: Heat-Treatment of Hard Waxy Wheat Flour—Closed Conditions

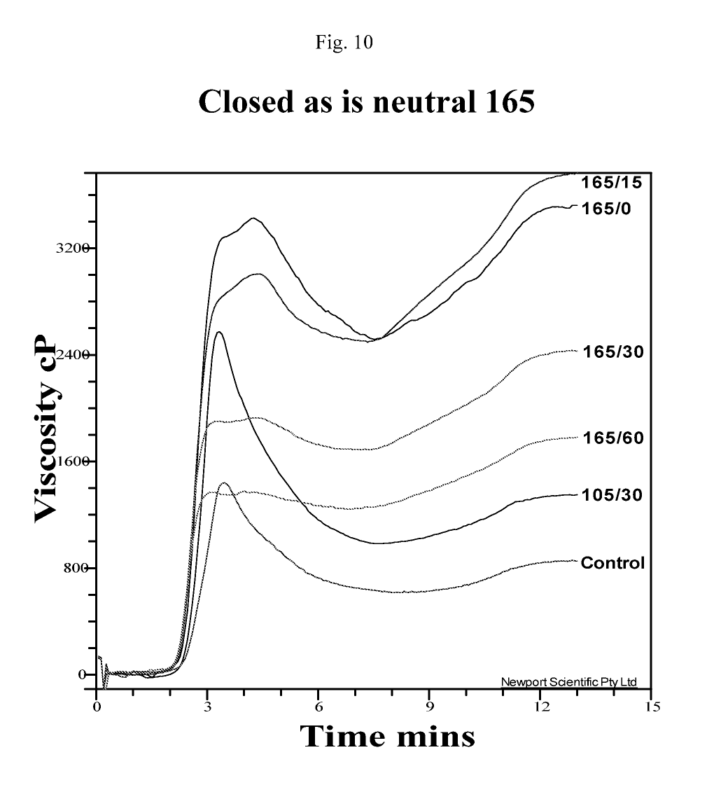

Hard waxy wheat flours were heat treated using the temperature profiles as described in Experiment 3. However, the flours were heat treated in a sealed glass jars instead of open conditions in Experiment 3. Heat treated hard waxy wheat flours had higher viscosity than the un-treated hard waxy wheat Hour (control)(FIG. 10). Viscosity breakdown was reduced alter heat treatment (165° C., 30 min) and the cook exhibited non-cohesive texture.

### Experiment 5: Heat-Treatment of Isolated Waxy Wheat Starch

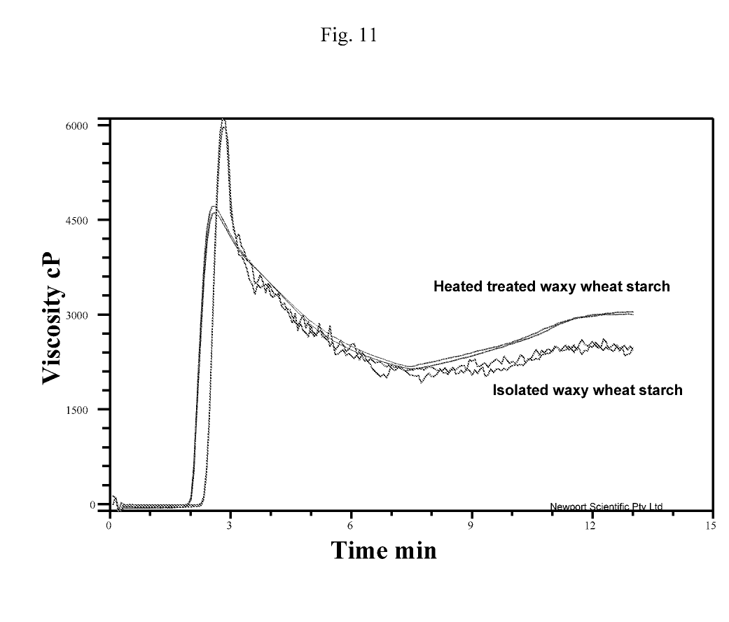

Waxy wheat starch was isolated from hard waxy wheat flour using a dough washing method. The isolated waxy wheat starch contains less than 0.5% protein and was heat treated as described in Experiment 3 and holding time at 165° C. was 30 min. The pasting properties (7% starch, pH 6) of isolated waxy wheat starch and heat treated waxy wheat starch were determined by RVA (FIG. 11, Table 3). In contrast to heat treated waxy wheat flours, heat treated (165° C. 30 min) waxy wheat starches showed large viscosity breakdown and the cooks were cohesive.

TABLE 3
Pasting properties (7% starch, pH 6) of native and
heat treated waxy wheat starch

| | | | | Cold | |
|---|---|---|---|---|---|
| | Peak | Hot Paste | Break | Paste | |
| Sample | Viscosity | Viscosity | Down | Viscosity | Set Back |
| Heated 165/30 | 4616.00 | 2141.00 | 2475.00 | 3049.00 | 908.00 |
| Heated 165/30 | 4717.00 | 2181.00 | 2536.00 | 3004.00 | 823.00 |
| Native waxy | 5963.00 | 1920.00 | 4043.00 | 2470.00 | 550.00 |
| wheat starch | | | | | |
| Native waxy | 6105.00 | 2079.00 | 4026.00 | 2432.00 | 353.00 |
| wheat starch | | | | | |

### Experiment 6: One-Step Direct Heat-Treatment of Waxy Wheat Flours

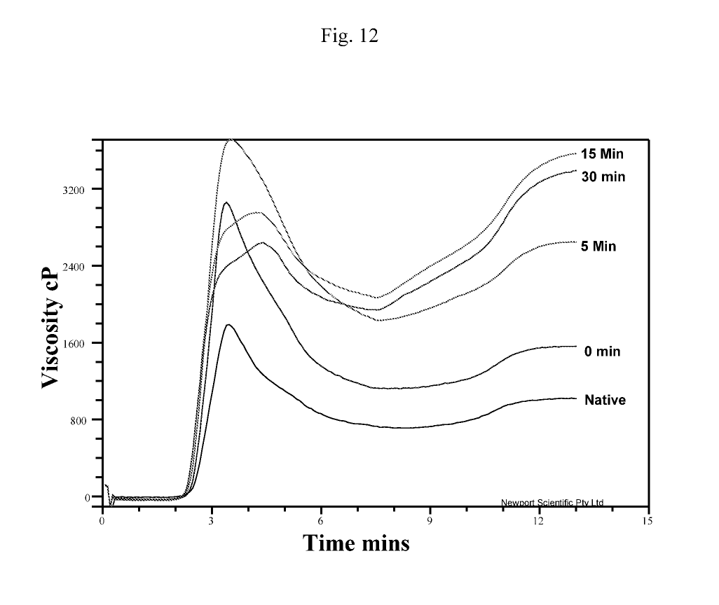

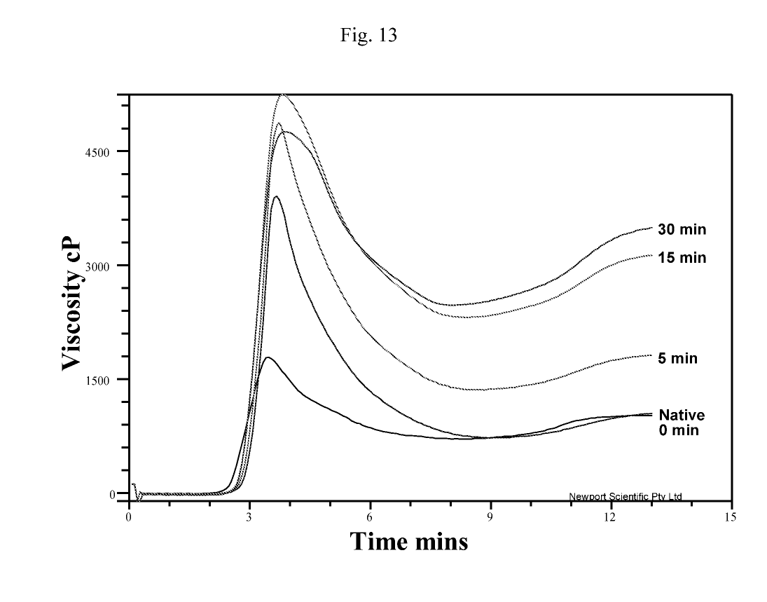

Waxy wheat flours (10 g each) were evenly spread onto aluminum fluted pans (121 mm diameter and 5 mm height) (Fisher Brand, Cat. No: 08-732-110) and placed in an oven that was pre-heated to 160° C. The temperature of the oven dropped when the door was open and the flours were placed into the oven. The temperature of the oven was increased back to 160° C. in 7 minutes and the flours were held at 160° C. for 0, 5, 15, and 30 minutes. The pasting properties of the heat treated flours were determined by RVA at neutral and slightly acidic pH. (FIGS. 12, 13). FIG. 12 shows the neutral pasting curves (10% solids, pH 6.0) of waxy wheat flours assayed via RVA at neutral pH heat treated at 160° C. for 0, 5, 15, 30 minutes. Heat treated samples had higher viscosity than the untreated waxy wheat flour (control) and the cooks 160° C., 15 and 30 minutes) were non-cohesive. FIG. 13 shows the pasting curves (10% solids, pH adjusted 3.0) of waxy wheat flours assayed via RVA at slightly acidic pH and heat treated at 160° C. for 0, 5, 15, 30 minutes. Heat treated samples had higher viscosity than the untreated waxy wheat flour (control) and the cooks (160° C., 15 and 30 minutes) were non-cohesive. Colorimeter analysis was performed using Minolta™ and was expressed as L (lightness).

TABLE 4
Colorimetry Analysis

| Temperature (° C.)/time (min) | L value |
|---|---|
| Native waxy wheat flour | 90.6 |
| 160/0 | 90.4 |
| 160/5 | 89.8 |
| 160/15 | 89.4 |
| 160/30 | 88.5 |

### Experiment 7: Heat Treatment of Waxy Wheat Flours at 15% Moisture.

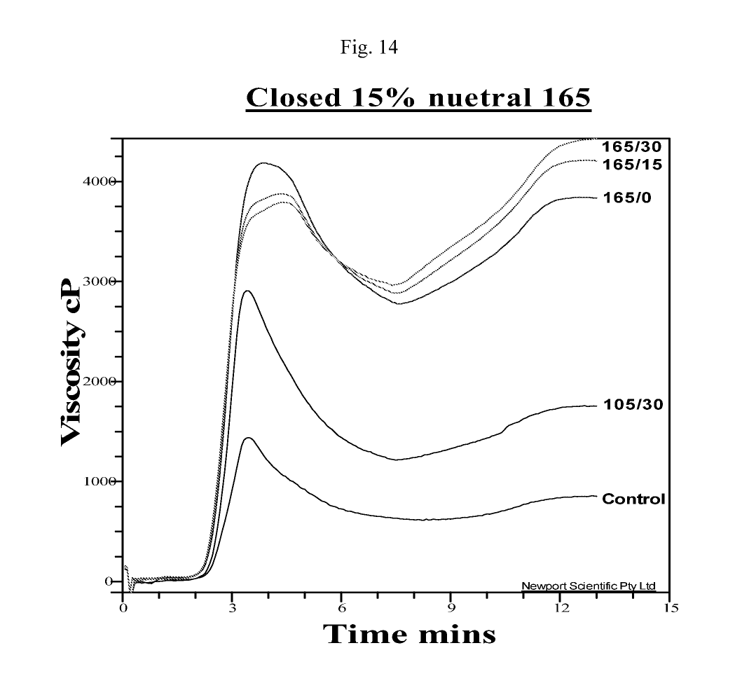

The moisture content of waxy wheat flour was increased to 15% using a humidity chamber. The flour samples (20 g each) were transferred to 12 ounces Quilted Crystal® Jelly Jars (Ball®: 14400-81200) and sealed. The jars were heated at 105° C. for 30 minutes and then the oven temperature was increased to 165° C. and held at that temperature for 0, 15, 30 minutes. The pasting properties (10% solids, pH 6.0) of heat treated flour were determined by RVA and were shown in FIG. 14. The flours heat treated at 160° C. had higher viscosity than the untreated waxy wheat flour and the cooks were non-cohesive.

### Experiment 8: Heat Treatment of Waxy Rice Flour

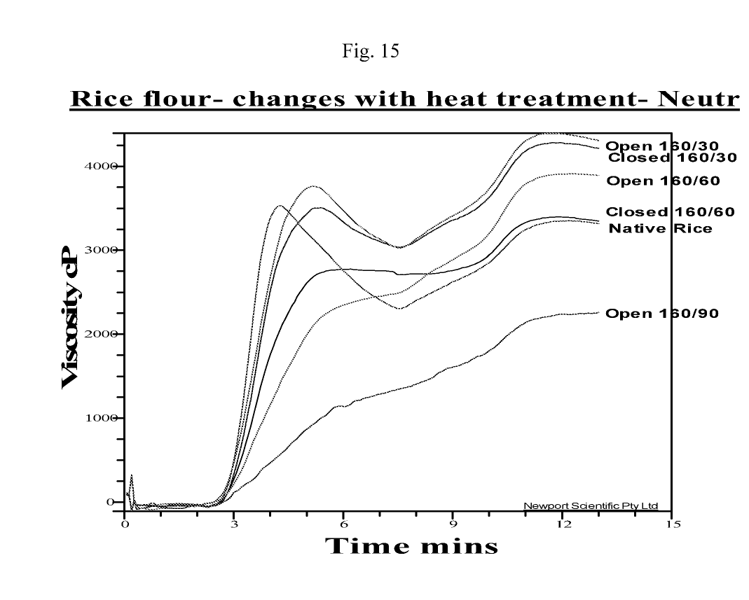

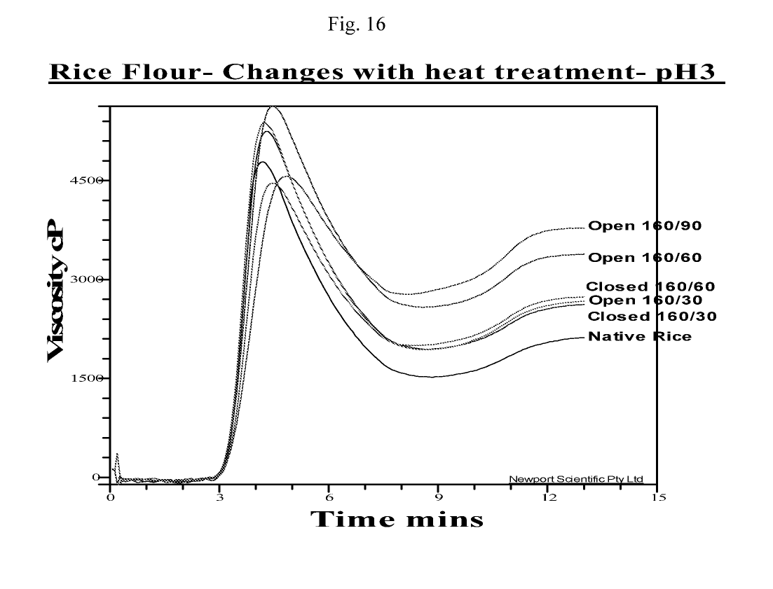

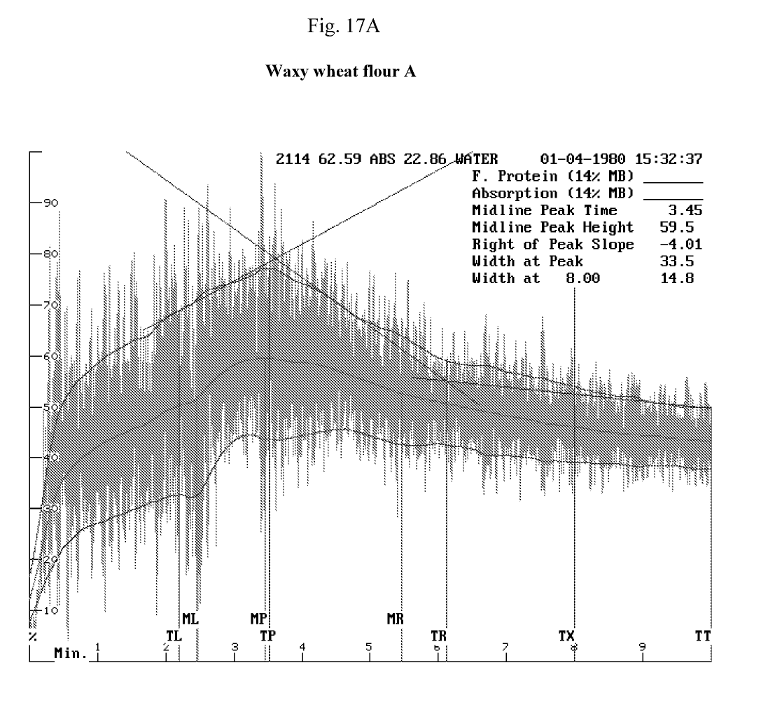

Waxy rice flour (Remylflo S 200, A&B Ingredients, Inc., New Jersey) was heated at 160° C. for 30, 60 or 90 minutes in open trays or in closed jars for 30 or 60 minutes. For open conditions, 10 g of sample was evenly spread onto a aluminum fluted pan 121 mm diameter and 5 mm height (Fisher Brand, Cat. No: 08-732-110). For closed conditions 20 g of sample was placed in a 12 ounces Quilled Crystal® Jelly Jars (Ball®: 14400-81200). Standard AACC methods were also followed for flour testing i.e. moisture content (AACC 44-15 A)(2000); Rapid Visco-Analyzer (RVA) (AACC 76-21)(2000) at 10% solids level. Colorimeter analysis was performed using Minolta™ and was expressed as L (lightness), a* (Green to Red) and b* (Blue to Yellow). Heat treated waxy rice flours (160° C., 30 and 6 minutes) had higher viscosity, less breakdown than the untreated waxy rice flour. (FIGS. 15, 16)(TABLES 5-8)

TABLE 5
Moisture content and RVA parameters
(at 10% solids) for rice flour

| | | | Water/Citrate |
|---|---|---|---|
| Sample | Moisture | Flour | Buffer |
| Native Rice Flour | 10.82 | 3.14 | 24.86 |
| Closed 160/30 | 6.29 | 2.99 | 25.01 |
| Closed 160/60 | 5.69 | 2.97 | 25.03 |
| open 160/30 | 7.79 | 3.04 | 24.96 |
| open 160/60 | 7.17 | 3.02 | 24.98 |
| open 160/90 | 6.50 | 2.99 | 25.01 |

TABLE 6
Colorimetric reading for heat treated rice samples

| Sample | L | a | b |
|---|---|---|---|
| Native | 90.48 | −2.21 | +9.84 |
| Closed 160/30 | 89.37 | −1.79 | +11.87 |
| Closed 160/60 | 89.30 | −1.09 | +14.43 |
| open 160/30 | 89.58 | −2.10 | +10.78 |
| open 160/60 | 87.91 | −1.59 | +13.50 |
| open 160/90 | 85.99 | −0.91 | +15.40 |

TABLE 7
RVA pasting properties (10% solids, pH 6.0)
of heat treated waxy rice flours

| | Peak | Hot Paste | | Final | | Peak | Pasting |
|---|---|---|---|---|---|---|---|
| Sample | Viscosity | Viscosity | Breakdown | Visc | Setback | Time | Temp |
| Native Rice | 3532 | 2307 | 1225 | 3316 | 1009 | 4.27 | 50.1 |
| flour | | | | | | | |
| Closed 160/30 | 3505 | 3033 | 472 | 4214 | 1181 | 5.4 | 69.35 |
| Closed 160/60 | 2774 | 2707 | 67 | 3347 | 640 | 6.2 | 69.35 |
| open 160/30 | 3761 | 3025 | 736 | 4305 | 1280 | 5.13 | 59.6 |
| open 160/60 | 2453 | 2353 | 100 | 3890 | 1537 | 7 | 61.3 |
| open 160/90 | 1286 | 1141 | 145 | 2259 | 1118 | 7 | 69.95 |

TABLE 8
RVA pasting properties (10% solids, pH 3.0)
of heat treated waxy rice flours

| | Peak | Hot Paste | | Final | | Peak | Pasting |
|---|---|---|---|---|---|---|---|
| Sample | Viscosity | Viscosity | Breakdown | Visc | Setback | Time | Temp |
| Native Rice | 4784 | 1518 | 3266 | 2118 | 600 | 4.2 | 67.1 |
| Flour | | | | | | | |
| Closed 160/30 | 5246 | 1942 | 3304 | 2621 | 679 | 4.33 | 64.6 |
| Closed 160/60 | 4461 | 1996 | 2465 | 2737 | 741 | 4.47 | 58.55 |
| open 160/30 | 5377 | 1932 | 3445 | 2670 | 738 | 4.2 | 71.85 |
| open 160/60 | 5629 | 2577 | 3052 | 3385 | 808 | 4.47 | 61.9 |
| open 160/90 | 4566 | 2773 | 1793 | 3774 | 1001 | 4.87 | 63.45 |

### Experiment 9: Rheological (Mixograph) Properties of Heat Treated Waxy Wheat Flour Dough

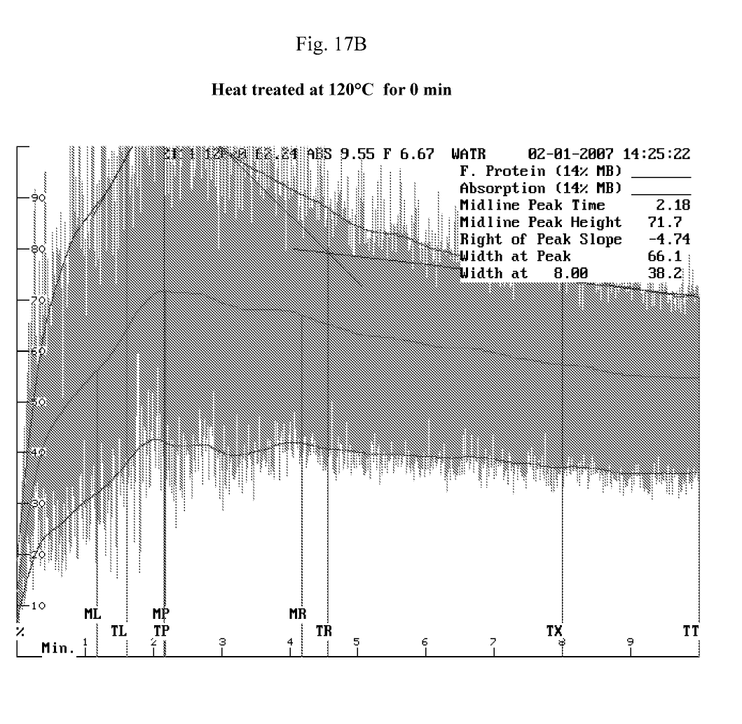

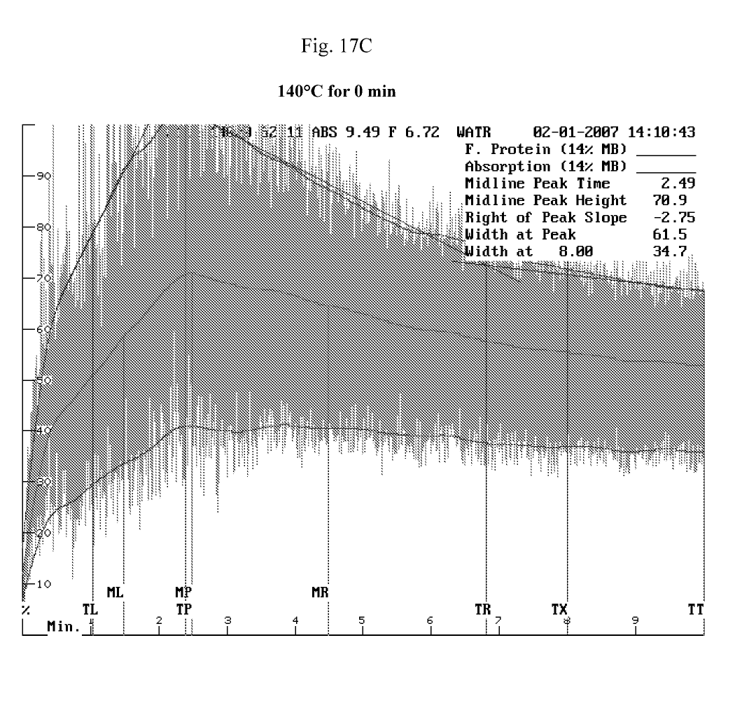

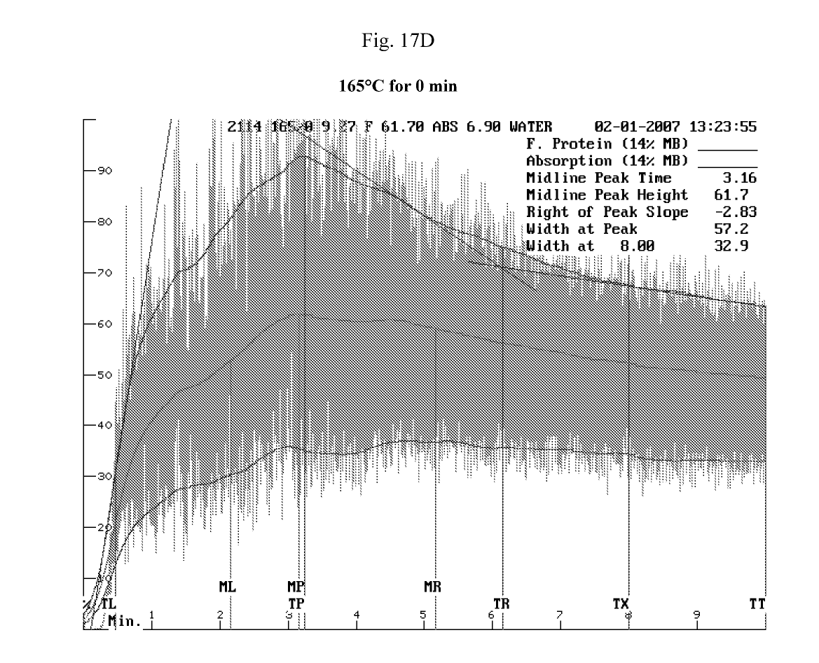

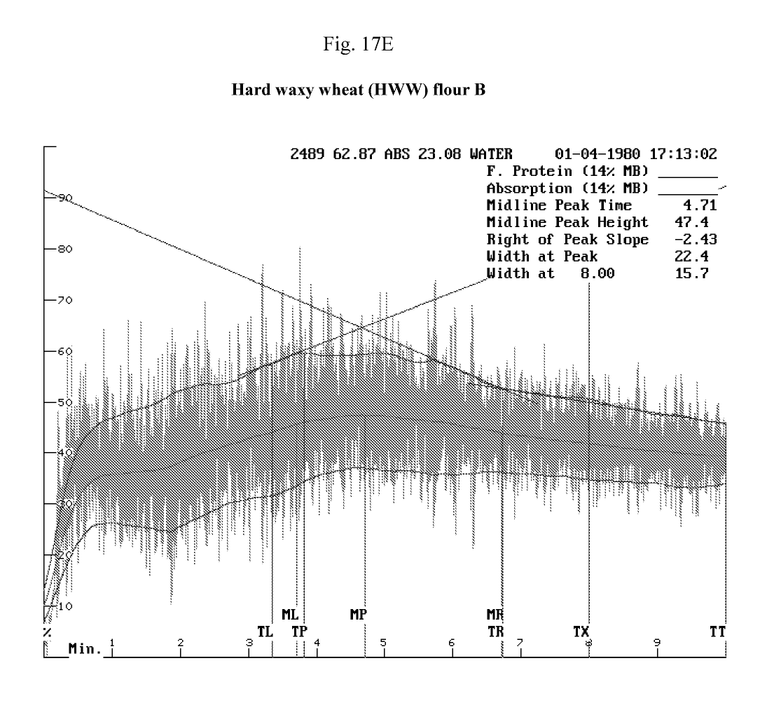

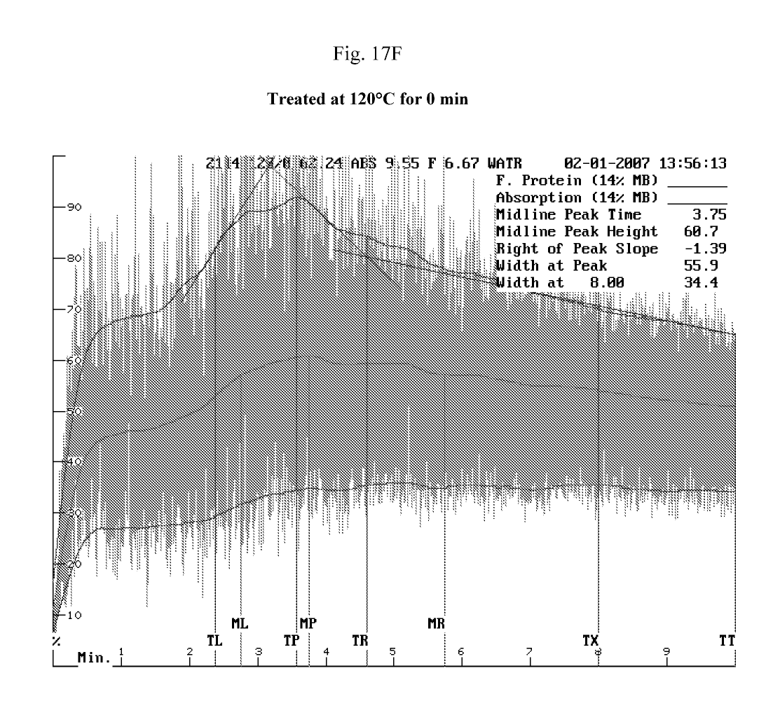

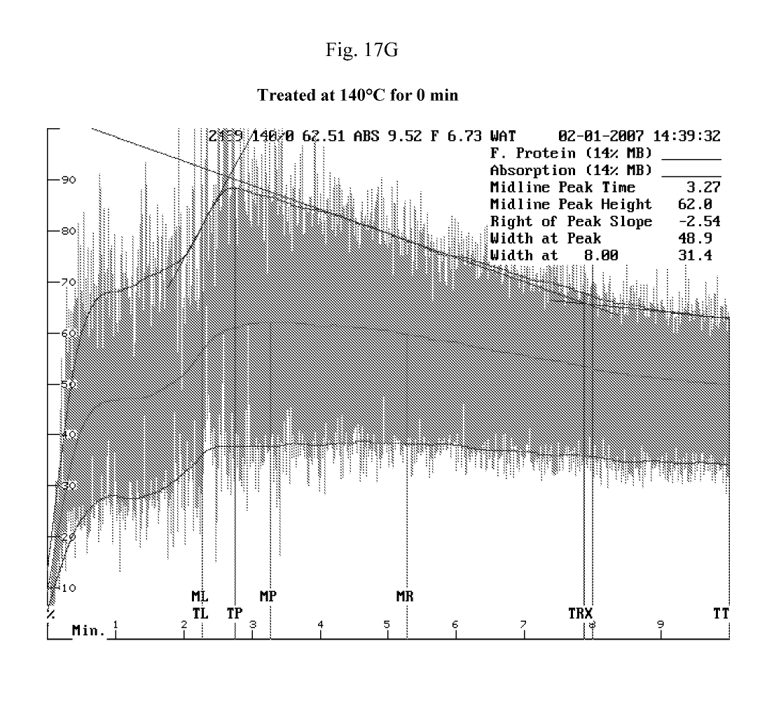

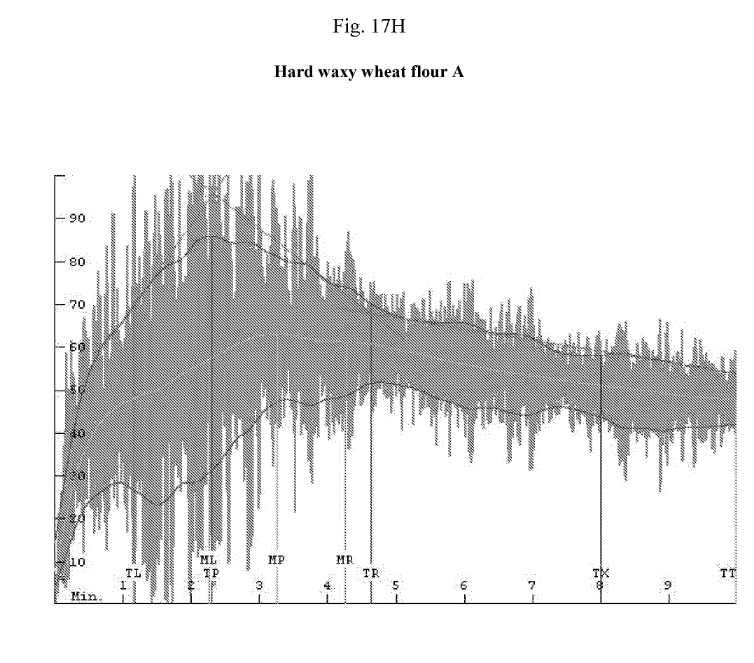

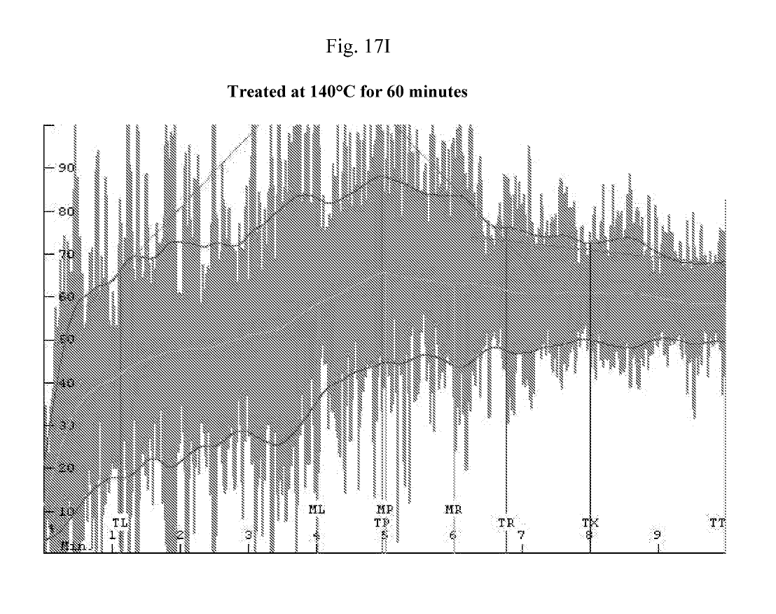

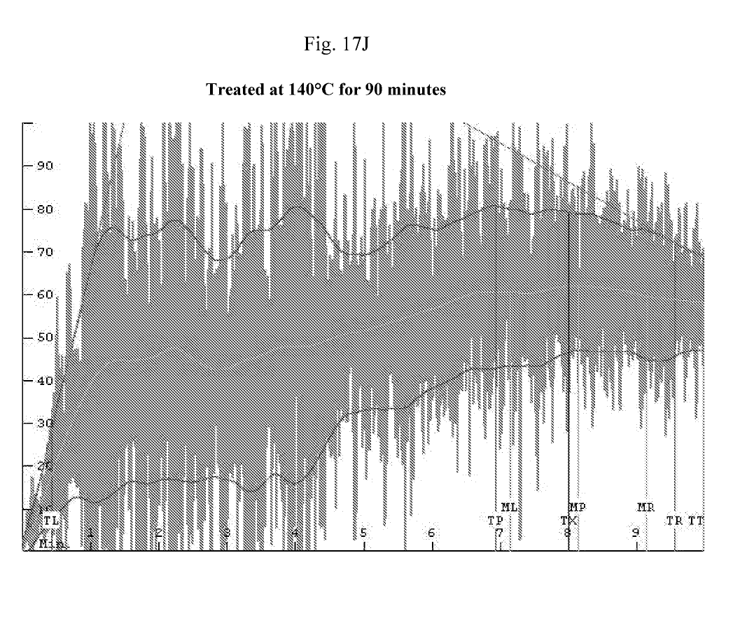

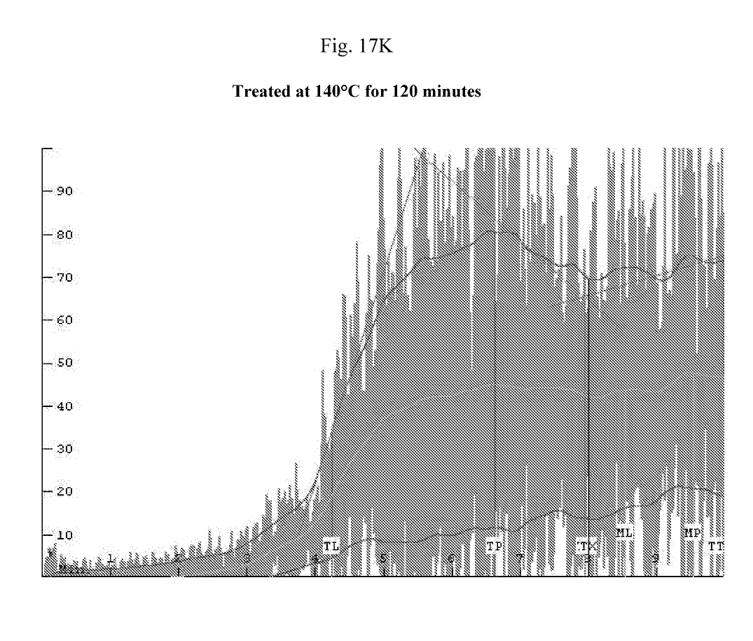

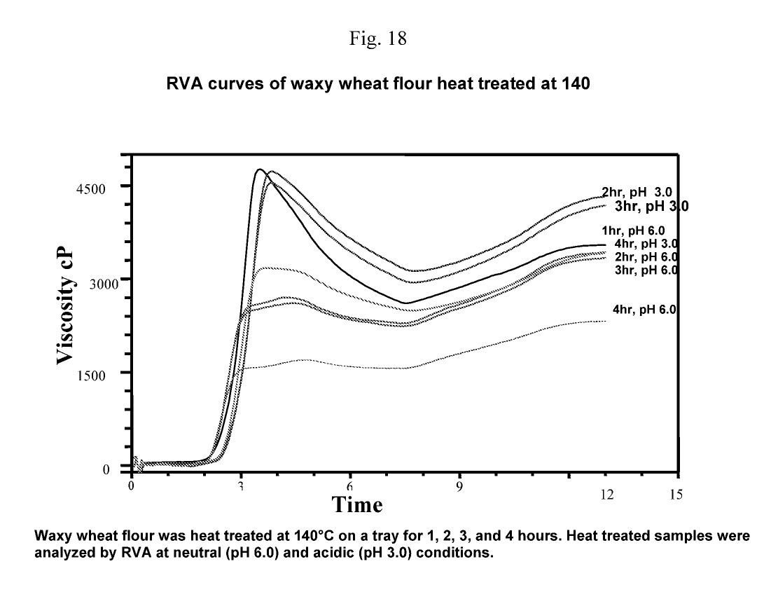

Two hard waxy wheat flours were used. Thermal processing conditions include single step, open heat treatment. The flour samples (about 20 g each) were evenly spread on a stainless steel plate (10 cm diameter) and were heated in a forced draft oven (Precision Equipment, Illinois) for desired time and temperature combination. Mixograph curves were obtained using a 10 gm mixer ((AACC Method 54-40 A). After heat treatment, waxy wheat flours became less sticky and less ductile. (FIGS. 17(a)-(i)).

### Experiment 10: Baking Studies

Breads were made by AACC method 10-10B using straight dough method with minor modifications. The baking formula (flour basis) was flour (14% moisture basis) 100.0 g, shortening (Crisco®) 3.0 g, and Malt 0.5 g. A two-step punching procedure was adopted using 180 min of fermentation. For control formulation, hard wheat flour (Karl '92) was used. For breads made with low levels of waxy wheat flour, Karl'92 flour (15.5% protein) was partially replaced with 5 and 10% heat treated hard waxy wheat flour (12.8% protein). Bread partially replaced with heat treated flours had larger loaf volume and good crumb structure.

TABLE 9
Loaf volume of bread made from normal hard wheat flour
and breads made with low levels of waxy wheat flour

| Sample | Loaf Volume (cc) |
|---|---|
| Normal Hard Red Winter Wheat (Karl′92) flour | 748 |
| Karl + 5% heat-treated hard waxy wheat flour | 808 |
| Karl + 10% heat-treated hard waxy wheat flour | 850 |

While a number of embodiments of the present invention have been described, it is understood that these embodiments are illustrative only, and not restrictive, and that many modifications may become apparent to those of ordinary skill in the art. For example, any steps may be performed in any desired order (and any desired steps may be added and/or any desired steps may be deleted). Further, any combination of inherent or adjusted pH or moisture content may be used for Hour undergoing heat treatment. Further, any combination of time, temperature, pH, and moisture content may be utilized.

What is claimed is:

1. A method comprising the steps of:
Obtaining a waxy flour; and
Heat treating the waxy flour, wherein the pH of the waxy flour is not adjusted during this method.

2. The method of claim 1, wherein the water content of the waxy flour is not adjusted during this method.

3. The method of claim 1, wherein the pH of the waxy flour is between about 4.5 and about 7.5.

4. The method of claim 1, wherein the water content of the waxy flour is between about 0 and about 18%.

5. The method of claim 4, wherein the water content of the waxy flour is adjusted to between about 0 and about 18% during this method.

6. A method comprising the steps of:
Obtaining a waxy flour; and
Heat treating the waxy flour, wherein the waxy flour is dehydrated prior to heat treating.

7. The method of claim 6, wherein the water content of the waxy flour is between about 0 and about 18% during this method.

8. The method of claim 7, wherein the pH of the waxy flour is between about 4.5 and about 7.5 during this method.

9. The method of claim 5, wherein the pH of the waxy flour is adjusted to between about 4.5 and about 7.5 during this method.

10. A heat treated waxy flour obtained using the method of claim 1.

11. The heat treated waxy flour of claim 10, wherein the heat treated waxy flour exhibits higher viscosity than comparable non-heat treated waxy flours.

12. The heat treated waxy flour of claim 10, wherein the heat treated waxy flour exhibits less viscosity breakdown than comparable non-heat treated waxy flours.

13. The heat treated waxy flour of claim 8, wherein the decrease in viscosity breakdown of heat treated waxy flour is observable in heat treated waxy flour with acidic pH.

14. A heat treated waxy flour obtained using the method of claim 6.

15. The heat treated waxy flour of claim 14, wherein the heat treated waxy flour exhibits higher viscosity than comparable non-heat treated waxy flours.

16. The heat treated waxy flour of claim 14, wherein the heat treated waxy flour exhibits less viscosity breakdown than comparable non-heat treated waxy flours.

17. The heat treated waxy flour of claim 14, wherein the decrease in viscosity breakdown of heat treated waxy flour is observable in heat treated waxy flour with acidic pH.

18. The heat treated waxy flour of claims 1 or 6, wherein the heat treated waxy flour exhibits less syneresis than comparable non-heat treated waxy flours.

19. The heat treated waxy flour of claims 1 or 6, where the heat treated waxy flour is selected from the group consisting of wheat, soft waxy wheat, hard waxy wheat, rice, corn, barley, sorghum, potato, cassava flour.

20. The heat treated waxy flour of claims 1 or 6, wherein the heat treated waxy flour exhibits decreased cohesion when subsequently heated in the presence of water as compared to non-heat treated waxy flour.
